(19) United States
(12) Patent Application Publication
(10) Pub. No.: US 2006/0121234 A1
(43) Pub. Date: Jun. 8, 2006

(54) Systems, compositions, and methods for laser imaging

(76) Inventors: Marshall Field, Corvallis, OR (US); Vladek Kasperchik, Corvallis, OR (US); Mehrgan Khavari, Corvallis, OR (US); David M. Kwasny, Corvallis, OR (US); Cari L. Dorsh, McMinnville, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/006,060

(22) Filed: Dec. 7, 2004

(51) Int. Cl. B32B 3/02; G11B 7/24; B05D 5/06

(52) U.S. Cl. 428/64.9; 428/64.2; 428/913; 427/162

(57) ABSTRACT

Disclosed herein are imaging materials and methods of making imaging materials. The imaging systems disclosed herein may include a reflective layer disposed proximate to and beneath a laser imageable layer on an optical disc.

### BACKGROUND

Materials that produce color change upon stimulation with energy such as laser radiation may have possible applications in imaging. For example, such materials may be useful in allowing the laser labeling and imaging of optical discs such as DVDs, and blue laser discs. One method of performing laser labeling or imaging of an optical disc involves layering onto the disc an imaging composition that changes color upon the application of laser light. However, some of the laser radiation may not be absorbed by the imaging composition and may pass into the other layers of the disc. Thus, because of this wasted energy, imaging may take longer than expected. Additionally, the radiation may reflect off of internal layers of the optical disc and be absorbed by the laser labeling layer in undesirable locations, possibly causing fuzzy images. Because of the limited amount of energy available for the imaging, the desire to perform imaging quickly, and the desire to produce sharp images it may be advantageous for the laser imaging system to efficiently use the laser energy available for labeling, while minimizing or decreasing the laser energy that is wasted or not used to produce the color change or causes color change in undesirable locations. Such an efficient system may increase the shelf life and/or sharpness of the images created on the optical disc.

### BRIEF SUMMARY

Disclosed herein are imaging materials and methods of making imaging materials. The imaging systems disclosed herein may include a reflective layer disposed proximate to and below a laser imageable layer.

### BRIEF DESCRIPTION OF THE DRAWINGS

For a detailed description of exemplary embodiments of the invention, reference will now be made to the accompanying drawings in which:

FIG. 1 shows a schematic cross-sectional drawing of an optical disc in accordance with embodiments of the present invention; and

FIG. 2 shows a schematic cross-sectional drawing of an optical disc in accordance with embodiments of the present invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “optical disc” is defined to include any optical disc (e.g., DVD or blue laser disc) having a data recording side upon which data is recorded by a laser having a wavelength of 750 nm or less. By way of example only, data is recorded onto a DVD by a laser having a wavelength of about 650 nm and data is recorded onto a blue laser disc by a laser having a wavelength of between about 400 nm and about 500 nm.

Additionally, spatially relative terms (e.g., lower, upper, below, above) are used herein for convenience. One of ordinary skill in the art will recognize that these terms are used merely for convenience and clarity and that the scope of the present invention will encompass any spatial configuration of the optical discs (by way of example only, upside-down, right-side-up, vertical, horizontal). By way of example only, when it is stated that one layer is “below” another in an optical disc, it is intended that the first layer is below the second layer when the optical disc is oriented with the label side pointing up. If the optical disc is turned data side up, the relative orientation of the layers has not changed.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

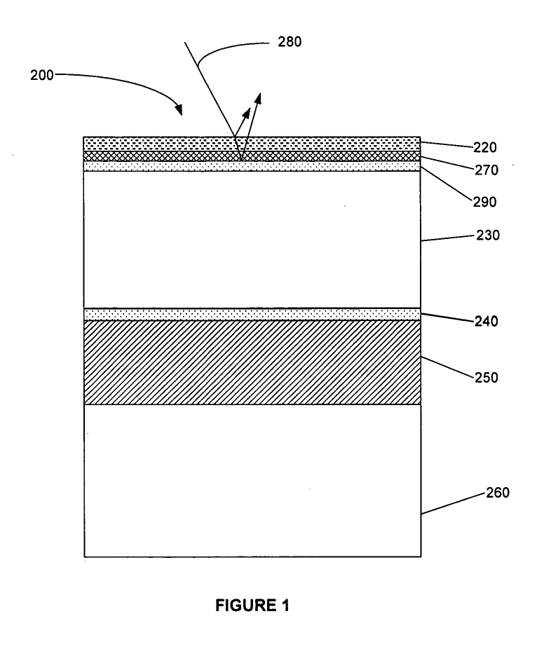

Referring now to FIG. 1, there is shown an optical disc 200 comprising several layers: lower polycarbonate 260, data layer 250, data reflective layer 240, upper polycarbonate layer 230, imaging reflective layer 290, protective layer 270, and laser labeling layer 220.

Optical disc 200 (e.g., a recordable DVD) comprises two polycarbonate layers (lower and upper) 260 and 230. In some embodiments, polycarbonate layers 260 and 230 are about 0.6 mm thick. Sandwiched between polycarbonate layers 260 and 230 is a data layer 250, backed by data reflective layer 240. To record data onto disc 200, a laser is shown through lower polycarbonate layer 260 onto data layer 250. The laser causes changes in data layer 240 which corresponds to the data being recorded.

On the labeling side of optical disc 200 is deposited laser labeling layer 220 which comprises a laser imageable composition which changes color upon the application of laser energy. By way of example only, the composition may comprise an antenna for absorbing laser energy, a leuco dye, an activator, and a matrix such as, by way of example only, described in United States Patent Application Publication No. 2004/0146812. The laser labeling layer 220 may be about 0.5 μm to about 14μ thick and be deposited, for example, by sputter coating, silk screening, spin coating, offset printing, flexographic printing, pad printing, or any type of printing or deposition process which may deposit a substantially uniform layer. In some embodiments, the laser labeling layer 220 may be about 7 μm to about 8 μm thick. In other embodiments, the laser labeling layer 220 may be about 4 μm to about 7 μm and in yet other embodiments, the laser labeling layer 220 may be about 1 μm to about 4 μm thick.

Beneath laser labeling layer 220 is imaging reflective layer 290. In some embodiments, imaging reflective layer 290 may be closer than about 50 μm below laser labeling layer 220 and may be greater than about 40 nm thick. In still other embodiments, imaging reflective layer 290 may be about 30 nm to about 200 nm thick. It is not necessary that image reflective layer 290 be immediately adjacent or with only protective layer 270 between imaging reflective layer 290 and laser labeling layer 220. In some embodiments, imaging reflective layer 290 may between about 0.5 μm to about 600 μm below laser labeling layer 220. In still other embodiments, imaging reflective layer 290 may be between about 0.5 μm and about 200 μm, between about 0.5 μm and about 50 μm, or between about 0.5 μm and about 10 μm below laser labeling layer 220. However, as imaging reflective layer 290 moves farther away from laser labeling layer 220, the effectiveness of imaging reflective layer 290 may be decreased.

Imaging reflective layer 290 may comprise any reflective coating capable of reflecting a substantial amount of the laser light 280 which is not absorbed by laser imageable layer 220 back up into laser imageable layer 220 where it has a second chance to cause a color change in laser imageable layer 220. By way of example only, imaging reflective layer 290 may comprise sputter coated or vacuum deposited Ag, Al, Au, Al/Cu alloy, Ag/Al alloy, metallic Si, Cu, brass, Zn, or any other metal, alloy, or composition which reflects laser light. Vacuum deposition may comprise using resistive heating to vaporize the metal to coat a substrate (e.g., an optical disc). Sputter coating may comprise creating a voltage difference between the substrate and the metal to create a plasma. In some embodiments, imaging reflective layer 290 is covered by protective layer 270. Protective layer 270 may be a lacquer which protects imaging reflective layer 270 from air and oxidation. By way of example only, acceptable lacquers may include spin coated UV curable acrylates such as Daicure Clear SD2200 or SD2407 (available from DIC Imaging Products U.S.A., Inc., Oak Creek, Wis.) and may be less than about 10 μm thick. In other embodiments, protective layer 270 may be about 4 μm to about 8 μm thick. In some embodiments the laser labeling layer may protect the reflective layer from oxidation and a separate protective layer may not be present.

In operation, laser radiation 280 is directed imagewise to laser labeling layer 220 where it makes a mark. At least a portion of the laser radiation 280 that is not initially absorbed by laser labeling layer 220 reflects back up to laser labeling layer 220 and some of the reflected laser radiation is then absorbed to enhance the mark. Laser radiation 280 may be any laser radiation which makes a mark on laser labeling layer 220. In some embodiments, the laser radiation may be of the same wavelength as the laser which writes data on the data layer 250 of the optical disc 200. In some embodiments, the laser radiation may have a wavelength of about 780 nm, about 650 nm, or about 400 nm-500 nm.

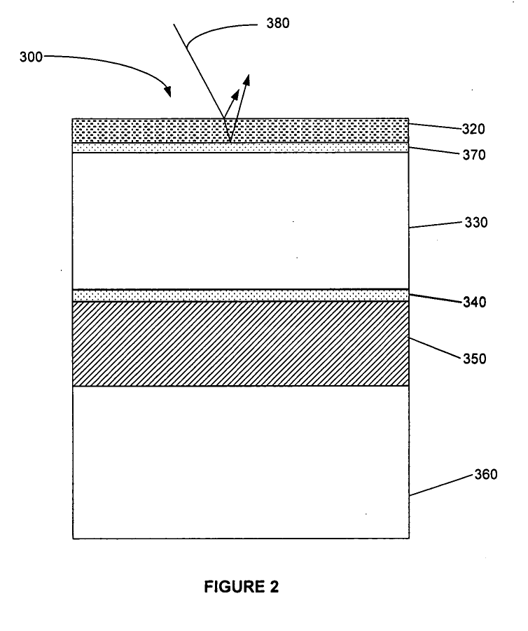

Referring now to FIG. 2, there is shown an optical disc 300 comprising several layers: lower polycarbonate layer 360, data layer 350, data reflective layer 340, upper polycarbonate layer 330, imaging reflective layer 370, and laser labeling layer 320.

In the embodiments of FIG. 2, as in the embodiments of FIG. 1, optical disc 300 (e.g., a recordable DVD) comprises two polycarbonate layers (lower and upper) 360 and 330. In some embodiments, polycarbonate layers 360 and 330 are about 0.6 mm thick. Sandwiched between polycarbonate layers 360 and 330 is a data layer 350, backed by data reflective layer 340. To record data onto disc 300, a laser is shown through lower polycarbonate layer 360 onto data layer 350. The laser causes changes in data layer 340 which corresponds to the data being recorded.

On the labeling side of optical disc 300 is deposited laser labeling layer 320 which comprises a laser imageable composition which changes color upon the application of laser energy. By way of example only, the composition may comprise an antenna for absorbing laser energy, a leuco dye, an activator, and a matrix such as, by way of example only, described in United States Patent Application Publication No. 2004/0146812. Laser labeling layer 320 may be about 7 μm to about 8 μm thick and be deposited, for example, by sputter coating, silk screening, or spin coating.

Beneath laser labeling layer 320 is imaging reflective layer 370. In some embodiments, imaging reflective layer 370 may be less than 50 μm below laser labeling layer 320 and may be greater than about 40 nm thick. In still other embodiments, imaging reflective layer 370 may be about 70 nm thick. It is not necessary that image reflective layer 370 be immediately adjacent to laser labeling layer 320. In some embodiments, imaging reflective layer may be between about 0.5 μm to about 600 μm below laser labeling layer 320. In still other embodiments, imaging reflective layer 290 may be between about 0.5 μm and about 200 μm, between about 0.5 μm and about 50 μm, or between about 0.5 μm and about 10 μm below laser labeling layer 220. However, as imaging reflective layer 370 moves farther away from laser labeling layer 320, the effectiveness of imaging reflective layer 370 may be decreased.

Imaging reflective layer 370 may comprise a lacquer containing suspended metal flakes which reflect light that is not absorbed by laser imageable layer 320 back up into laser imageable layer 320 where it has a second chance to cause a color change in laser imageable layer 320. By way of example only, imaging reflective layer 370 may comprise a paste/lacquer containing aluminum flakes (called “silver paste”); copper flakes (called “gold paste”); brass flakes (called “bronze paste”); or Ag, Cu, or Zn suspended in a paste or lacquer. In some embodiments, the “silver paste” may be Eckart SP8700 UV-curable lacquer (available from Eckart America L.P., Louisville, Ky.). In other embodiments, imaging reflective layer 370 may comprise solvent-based undercoats such as Eckart SX9102 (metal flakes suspended in propylene glycol and butoxyl ethanol).

In operation, laser radiation 380 is directed imagewise to laser labeling layer 320 where it makes a mark. At least a portion of the laser radiation 380 that is not initially absorbed by laser labeling layer 320 reflects back up to laser labeling layer 320 and some of the reflected laser radiation is then absorbed to enhance the mark. Laser radiation 380 may be any laser radiation which makes a mark on laser labeling layer 320. In some embodiments, the laser radiation may be of the same wavelength as the laser which writes data on the data layer 350 of the optical disc 300. In some embodiments, the laser radiation may have a wavelength of about 780 nm, about 650 nm, or about 400 nm-500 nm.

### EXAMPLES

### Example 1

A 50 nm to 100 nm thick reflective layer of Al was sputter coated onto a DVD. The reflective layer was then spin coated with Daicure SD2200 protective lacquer and cured for 1-3 seconds. An 8 μm laser labeling layer was screen printed over the cured lacquer and reflective layer. After the laser labeling layer was cured, a mark was made using a 38.25 mW/780 nm laser. In measuring shelf life over the course of 48 hours at 30% relative humidity the disc having a reflective layer performed better than marks made on DVDs which did not include a reflective layer. After 48 hours, the optical density of DVD with the Al undercoat had faded about 33% less than the mark on the uncoated DVD.

### Example 2

A reflective layer of UV curable Eckart SP8700 “silver paste” was screen printed onto a DVD and cured for 1 to 3 seconds. An 8 μm laser labeling layer was screen printed over the cured lacquer and reflective layer. After the laser labeling layer was cured, a mark was made using a 38.25 mW/780 nm laser. In measuring shelf life over the course of 48 hours at 30% relative humidity the disc having a reflective layer performed better than marks made on DVDs which did not include a reflective layer. After 48 hours, the optical density of DVD with the silver paste undercoat had faded about 10% less than the mark on the uncoated DVD.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An optical recording medium comprising:
an optical disc;
wherein the optical disc comprises a data recording side and an image recording side;
wherein the image recording side comprises a reflective layer beneath a laser labeling layer;
wherein the reflective layer is less than 600 μm from the laser labeling layer.

2. The optical recording medium of claim 1 wherein the reflective layer is less than about 200 μm from the laser labeling layer.

3. The optical recording medium of claim 1 wherein the reflective layer is less than about 50 μm from the laser labeling layer.

4. The optical recording medium of claim 1 wherein the reflective layer comprises a sputter coated metal.

5. The optical recording medium of claim 1 wherein the reflective layer comprises a metal selected from the group consisting of Al, Au, Ni, Cr, Rh, and Ag.

6. The optical recording medium of claim 1 wherein the reflective layer is protected from exposure to oxygen.

7. The optical recording medium of claim 1 wherein the reflective layer comprises metal flakes suspended in a lacquer.

8. The optical recording medium of claim 7 wherein the reflective layer comprises metal selected from the group consisting of aluminum flakes, silver flakes, and gold flakes suspended in a lacquer.

9. The optical recording medium of claim 1 wherein the optical disk is selected from the group consisting of DVDs and blue laser discs.

10. A method for preparing an optical disc having a data side and an label side, the method comprising:
providing an optical disc;
layering a reflective layer on the label side of the optical disc;
layering a laser imageable layer over the reflective layer.

11. The optical recording medium of claim 10 wherein the laser imageable layer is less than about 200 μm from the reflective layer.

12. The optical recording medium of claim 10 wherein the laser imageable layer is less than about 50 μm from the reflective layer.

13. The method of claim 10 wherein the optical disc is selected from the group consisting of DVDs and blue laser discs.

14. The method of claim 10 wherein the reflective layer comprises a sputter coated metal.

15. The method of claim 13 wherein the reflective layer comprises a metal selected from the group consisting of Al, Au, Ni, Cr Rh and Ag.

16. The method of claim 10 further comprising the step of layering a protective coating over the reflective layer prior to layering the laser imageable layer over the reflective layer.

17. The method of claim 10 wherein the reflective layer comprises metal flakes suspended in a lacquer.

18. The method of claim 17 wherein the reflective layer comprises metal selected from the group consisting of aluminum flakes, silver flakes, and gold flakes suspended in a lacquer.

19. A laser imaging means comprising:
a laser imageable means coated over a reflective means, wherein the reflective means and the laser imageable means are coated onto an optical disc.

20. The laser imaging means of claim 19 wherein the optical disc is selected from the group consisting of DVDs and blue laser discs.

21. The laser imaging means of claim 19 wherein the reflective means comprises a sputter coated metal.

22. The laser imaging means of claim 21 wherein the reflective means comprises a metal selected from the group consisting of aluminum, gold, nickel, rhodium, chromium and silver.

23. The laser imaging means of claim 19 wherein the reflective means comprises metal flakes suspended in a lacquer.

24. The laser imaging means of claim 23 wherein the metal flakes comprise a metal selected from the group consisting of aluminum, gold, nickel, rhodium, chromium and silver.

25. The laser imaging means of claim 19 wherein the reflective means are protected from exposure to oxygen by a protective means.
